(19) United States
(12) Patent Application Publication
(10) Pub. No.: US 2024/0075651 A1
(43) Pub. Date: Mar. 7, 2024

(54) A NOVEL THREE-DIMENSIONAL CERAMIC PRINTER HAVING A PRINTING POWDER COMPRESSION SYSTEM

(71) Applicant: Advanced Development of Additive Manufacturing, Inc., Stamford, CT (US)

(72) Inventors: Arkadii Bohdan, Odessa (UA); Mykhailo Pluzhnyk-Gladyr, Odessa (UA); Oleg Rogankov, Odessa (UA); Vadym Volkov, Odessa (UA)

(21) Appl. No.: 18/037,891

(22) PCT Filed: Nov. 11, 2021
(86) PCT No.: PCT/US21/59021

§ 371 Date: May 19, 2023

Related U.S. Application Data
(60) Provisional application No. 63/115,910, filed on Nov. 19, 2020.

(51) Int. Cl. B28B 1/00

(52) U.S. Cl. CPC B28B 1/001; B33Y 30/00

(57) ABSTRACT

The instant invention describes a three-dimensional ceramic printer and methods for printing products from ceramic precursors or powders. The printer comprises a printer body attached to a printing chamber, a printing plate having a printing movement axis and a printing drive, a first feed chamber and a second feed chamber positioned on the opposing sides of the printing chamber. The printer further comprises a guide rail positioned above the chambers, and a print head movably attached to the guide rail. The guide rail further comprises a printing axis having a mounting frame, a printhead, a shaft and belt units. The shaft is attached to the printing axis at one of the sides of the print head. The first and second feed chambers may each contain a volume of print media, and the shafts may alternatingly deposit a volume of print media from each feed chamber onto the printing chamber.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This patent specification relates generally to the field of three-dimensional printers and methods for making ceramic objects using a three-dimensional printer.

The instant invention includes a detailed procedure of printer operation. The detailed specification includes laboratory testing, which were designed to improve printer efficiency and effect, and the results of the related characteristics and properties of the resultant printed product were measured. The instant printer and method enable a unique set of characteristics in the resultant printed product, such as, but not limited to, ultimate strength, density, porosity, shrinkage, all of which were compared with the known technology of ceramics 3D printing. The instant invention offers unique and non-obvious advantages over those mentioned in the known art.

### BACKGROUND

Three-dimensional (3D) printed performance ceramics have been available via a variety of additive manufacturing platforms for some time. Achievement of the quality characteristics close to the traditional technology of ceramic manufacturing combined with the capability of printing complex shapes should bring ceramic production to the next level. The most complete overview of the achievements and problems in this area of additive manufacturing was presented in the article entitled “Binder jetting of ceramics: Powders, binders, printing parameters, equipment, and post-treatment” (2019) by Xinyuan Lv et al.

U.S. Pat. No. 8,845,953B1 to Balistreri is a known prior art in ceramic 3D printing that generally discloses methods of preparing a ceramic precursor article, the ceramic precursors made thereby, and methods of making ceramic article and an article made by that method. It also includes a method of replicating a ceramic shape. Also included is a method of making a ceramic precursor, and the finished ceramic article therefrom, involving a compression step, and a compression-capable printer apparatus. The prior art could not be modified to achieve our results because the liquid binder used by the method discussed, cannot be used with the printhead of the other type, due to its composition and specific physical parameters of it. The change of the printhead and the liquid binder composition will cause the change of the powder precursor composition because of the absence of the binder agents in it. Adding the opposite feed chamber will lead to a complete rework of the printing part of the printer, as well as the entire sealing mechanism, so that they allow applying and sealing on both sides, respectively, otherwise the printer will not be able to perform its function.

Most of the patents considered (such as U.S. Pat. No. 9,908,819B1 by Wolfgang Kollenberg) describe the technology in a broad sense, without giving any precise information beyond a general understanding of the subject matter. US20180354860A1 describes the method of using extrusion 3D printing to create ceramic products, using a syringe with a gel-like suspension applied layer by layer and retained by a layer of oil. This technology is interesting for further development and improvement efforts, but its current capabilities for the production of complex ceramic objects are very limited by the printing method and the likelihood of achieving a quality result somewhat comparable to traditional technology is small.

The patents “Method of three-dimensional printing” U.S. Pat. No. 5,902,441A and “Three-dimensional printing material system and method” U.S. Pat. No. 7,087,109B2 obtained by Bredt et al. describe the technologies of using inkjet printheads for jetting the binder liquid to the spread layer of powder to bond the powder particles. Commercially available printers, like those from Zcorp of Burlington, Mass, operate according to this technology. This technology also served as the basis for the other works of its improvement such as patents US20020016387A1 by Jialin Shen and US20040081573A1 by Kenneth Newell.

John A. Balistreri and Sebastien Dion achieved most advanced results in this direction, claimed in their patent “Three-dimensional printer, ceramic article and method of manufacture” U.S. Pat. No. 8,845,953B1 where, in addition to various compositions of the binder and ceramic precursors, there is also a method of compression of the applied layer of ceramic precursor and a mechanism that allows this compression to be performed. However, the usage of binder compositions described is extremely inconvenient in practice, because it requires being very careful with the print head, since the binder often clogs the nozzle plate and the print head quickly deteriorates. And the statement about the high porosity of the sintered product due to the presence of binding polymers in the composition of the ceramic precursor, which burn out during sintering does not justify it, since in the presence of a sufficient amount of a binder, the polymer particles dissolve in it, evenly distributed in volume and thus create a homogeneous structure. The described procedure for compressing the ceramic precursor layer obviously leads to a significant slowdown in printing. Additionally, based on the experience of using printers from Z-corp, it can be argued that this method of applying a ceramic precursor only from one side of the printing chamber, significantly impairs the strength of the structure and the homogeneity of the printed object.

So, notwithstanding the above-named developments, most current consumer 3D printing platforms are unable to manufacture ceramic objects with a sufficient amount of high speed or precision. Any structure property (porosity, etc.) is hardly controllable and the mechanical characteristics are extremely low, comparable to the traditional methods of manufacturing (cast molding, etc.). This was the reason, why typically for early generations of ceramic 3D-printing, these platforms were printing a model as a pre-product for further making of casting molds or press-molds instead of direct printing of a ceramic object itself. Including processes of firing and glazing of the obtained ceramic object, it can take up to 10 days to produce a single ceramic object. Combination of these factors led to the need to improve 3D printing technology for use in the ceramic industry.

### BRIEF DESCRIPTION OF THE DRAWINGS

The present embodiments of the instant invention are illustrated by way of example and are not intended to be limited by the figures of the accompanying drawings.

FIG. 1 depicts a general schematic view of the preferred embodiment of the device with the key parts and mechanisms marked on it.

FIG. 2 depicts a schematic view of the device and the operation of its mechanisms corresponding to preparatory step 201, the preferred direction of movement is shown by arrows.

FIG. 3 depicts a schematic view of the device and the operation of its mechanisms corresponding to powder spreading step 202, the preferred direction of movement is shown by arrows.

FIG. 4 depicts a schematic view of the device and the operation of its mechanisms corresponding to compaction step 203, the preferred direction of movement is shown by arrows.

FIG. 5 depicts a schematic view of the device and the operation of its mechanisms corresponding to binder applying step 204, the preferred direction of movement is shown by arrows.

FIG. 6 depicts a schematic view of the device and the operation of its mechanisms corresponding to preparatory step 205, the preferred direction of movement is shown by arrows.

FIG. 7 depicts a schematic view of the device and the operation of its mechanisms corresponding to powder spreading step 206, the preferred direction of movement is shown by arrows.

FIG. 8 depicts a schematic view of the device and the operation of its mechanisms corresponding to compaction step 207, the preferred direction of movement is shown by arrows.

FIG. 9 depicts a schematic view of the device and the operation of its mechanisms corresponding to binder applying step 204, the preferred direction of movement is shown by arrows.

FIG. 10 depicts a schematic view of the preferred embodiment of the device described herein with the green sample finished in it as a result of the procedure described herein.

FIG. 11 depicts a scheme, a 3D model and a printed and sintered product of a ceramic cup made from hydro-aluminosilicate powder as a raw material.

FIG. 12 depicts a scheme, a 3D model and a printed and sintered product of a radial bone implant made from a hydroxyapatite-based powder as a raw material.

FIG. 13 depicts a 3D model and a printed and sintered welding ferrules made from cordierite powder as a raw material.

FIG. 14 depicts one of the test samples a laboratory press with a pressure gauge a crashed test sample.

FIG. 15 depicts four graphs showing inventive characteristics based on density, compressive strength, green samples shrinkage, and sintered samples shrinkage for any ceramic composition according to the main embodiments of the invention.

FIG. 16 depicts objects printed using cordierite powder, having the following b/v ratios:
a. a b/v ratio in range from 0.20 to 0.29
b. a b/v ratio in range from 0.37 to 0.40
c. a b/v ratio in range from 0.30 to 0.36

### BRIEF DESCRIPTION OF THE INVENTION

A three-dimensional ceramic printer is provided. In the preferred embodiment, the printer may include a printer body which may be attached to a printing chamber. A printing plate may be movable within the printing chamber via a printing movement axis and a printing drive. A first feed chamber and a second feed chamber may be placed in the printer body on the opposing sides of the printing chamber. A first feed plate may be movable within the first feed chamber via a first feed axis and a first feed drive, and a second feed plate may be movable within the second feed chamber via a second feed axis and a second feed drive. A guide rail may be positioned above the chambers and a print head may be movably attached to the guide rail via a printing axis. A printing axis is a movable mounting frame that is connected to the guide rail and carries a printhead, shaft and belt units. A shaft may be attached to the printing axis at one of the sides of the print head. The feed chambers may each contain a volume of print media, and the shafts may alternatingly deposit a volume of print media from each feed chamber onto the printing chamber.

Between the alternating deposits of print media, the printhead may be configured to deposit a volume of binding liquid onto desired positions of the print media in the printing chamber to form a desired object out of a plurality of alternating layers of print media and binding liquid.

A method of using a three-dimensional ceramic printer to make three dimensional ceramic objects is provided. The method may include: lowering a printing plate in a printing chamber to an appropriate height, raising the first feed plate to an appropriate height and lowering the second feed plate to an appropriate height; depositing a layer of print media from the first feed chamber onto the printing plate; compressing the deposited layer; depositing binding liquid onto desired positions of the print media in printing chamber; lowering the printing plate to an appropriate height, raising the second feed plate to an appropriate height and lowering the first feed plate to an appropriate height; depositing print media from the second feed chamber onto printed layer in the printing chamber; compressing the deposited layer; depositing binding liquid onto desired positions of the print media in printing chamber. This sequence is repeated if the current layer is not the last.

The ceramic composition for 3D printing may comprise any combination of one or more basic compounds with other ancillary materials. The main forming component is selected based on the desired chemical composition and technical properties of the final product. Likewise, auxiliary materials, in addition to their specific role in printing or sintering, must meet these requirements. Auxiliary materials can play the role of a binding agent during printing, a free-flowing filler of the large pores between the particles of the forming component, flux that promotes the formation of bonds between the particles of the forming component during sintering, as well as a filler that makes it possible to reduce shrinkage during sintering.

Depending on the intended purpose of the final product, one of hydroaluminosilicate powders or cordierite powders or mullite-corundum powders may be the basic component. The shrinkage reducing filler can be chamotte powder made by firing the base component or any other compound of a similar chemical composition with the same or higher melting point to high temperature before grinding and screening it to specific particle sizes. It is preferable that one auxiliary material can perform several functions: chamotte powder, having a sufficiently high flowability, can also act as a free-flowing filler with proper granulometry.

A substance with a lower melting point than the base component, close to it in chemical composition, may act as a flux. It is preferable that the flux has a slightly lower melting point (within −50 degrees). The binding agent may be any water-soluble polymer such as PVA or polyvinyl alcohol or any polysaccharide or polyvinylpirrolidone. It is preferable to use polysaccharides that dissolve rapidly in water forming a viscous maltose syrup that easily binds the powder particles in a time interval from 2 to 6 hours. For more precise control of the porosity of the final product, which is required in such areas as printing ceramic bone implants, a certain proportion of water-insoluble polymer with granule sizes close to the required pore sizes can be included in the ceramic precursor powder.

The preferred ceramic composition for 3D printing consists of:
a. from about 50% to about 80% basic ceramic component;
b. up to about 25% free-flowing filler;
c. up to about 15% shrinkage reducing filler;
d. up to about 15% flux;
e. up to about 15% binding agent.

Theoretical and practical study of the effect of the granulometric composition of the powder on the bulk density and flowability has shown that for higher values it is preferable that the powder consisted of a certain proportion of coarse filler in combination with a finer one. Moreover, the difference in size between large and small grains should be as large as possible. It is preferable that the size of large grains is 8-9 times larger than the size of small ones, and their volume fraction is 4 times larger. The most preferred granulometric composition consists of:
a. from about 20% to about 30% fine filler (0-15 microns);
b. from about 70% to about 80% coarse filler (60-80 microns).

The binder, in accordance with the above, is a binding liquid that may include water as the main component and various auxiliary components designed to make the physical properties of the binding liquid acceptable for the printhead. Auxiliary components in the composition of the liquid part of the binder can act as a coagulant added to achieve purity of the solution and remove suspended particles from it that clog the nozzles of the print head. They can increase the flowability of the solution, adjust the viscosity, surface tension and Ph.

Water acts as a solvent and serves as a liquid part of the combined binder, which, upon contact with a binding agent in the composition of the powder, dissolves the particles of the polysaccharide or any other component of the ceramic precursor powder intended for bonding the ceramic components of the precursor powder. The combination of ethanol and glyceryl cocoate may be used to decrease surface tension of solution. Ethylene glycol may be used to increase viscosity of water up to the level preferable for operating the selected printhead.

The preferred binder for 3D printing may additionally contain:
a. from about 0.5 to about 3% ethanol;
b. from about 5 to about 15% ethylene glycol;
c. from about 0.1 to about 1% glyceryl cocoate

Most preferably, the binder comprises preservatives from 0.2% to 2%.

The binder/volume ratio is a value characterizing the necessary and sufficient amount of binding fluid applied to the layers of the ceramic powder-precursor for their binding into a single object. The U.S. Pat. No. 8,845,953B1 claims a large shrinkage of the final objects due to the presence of binding agents in the composition of the ceramic powder used for printing. Undissolved polymer grains, burning out during sintering, increase porosity at the initial stages of sintering and, consequently, the overall shrinkage. However, further studies in this area have shown that this happens only when there is an insufficient amount of a binder liquid applied to the powder layer. Establishing the optimal ratio of the binder to the volume of the powder is an important part in the described technology of ceramic products fabrication and ensures uniform distribution of the binder in the volume of the green sample. As a result, the sample shrinks (about 1%) already during printing and drying, but its strength increases significantly both in green and sintered form. In addition, the distinction between the shrinkages of top and bottom sides decreases or disappears.

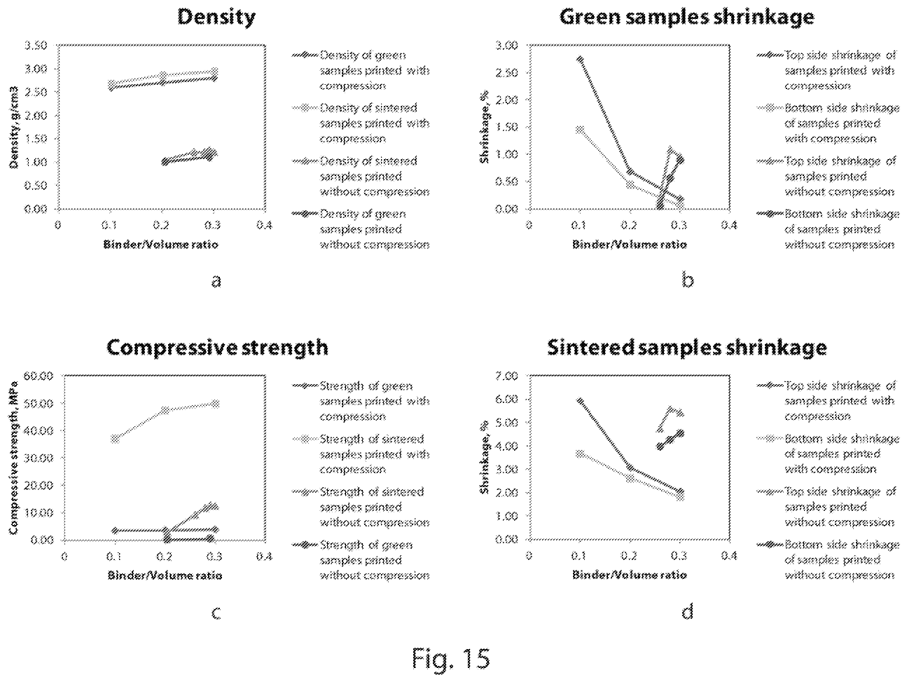

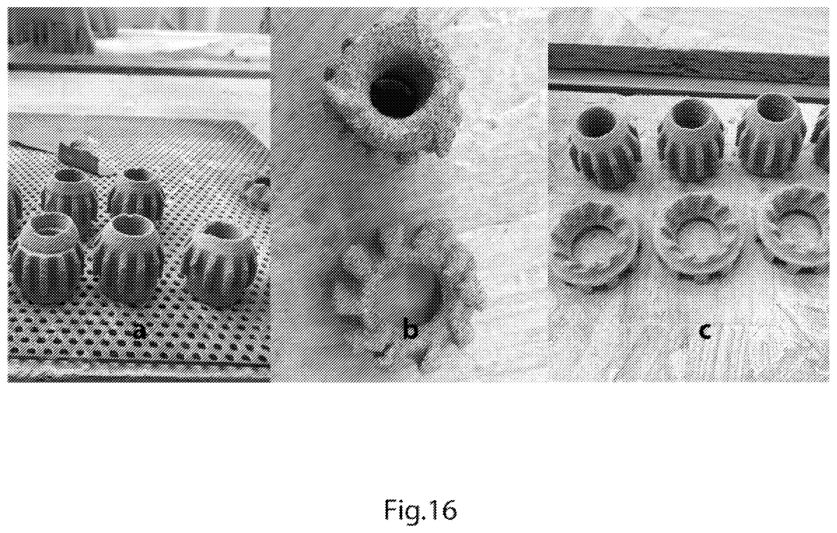

Different binder/volume ratios were tested. A consistent increase in the binder/volume ratio, starting from about 0.1 up to 0.4, first gave a noticeable improvement in the quality parameters of green and sintered samples (their strength, density, hardness, surface smoothness). The homogeneity of the internal structure also increased, as evidenced by the practical absence of a leader and a more uniform shrinkage throughout the sample volume. However, upon reaching a certain level, the qualitative improvement stopped, on the contrary, a noticeable deterioration in the surface properties of the product became apparent, due to the large number of adhesions of excess print media 20 particles. This fact is illustrated by the graph of changes (FIG. 15c) in the strength characteristics of the final product made from one of our hydro-aluminosilicate ceramic mixtures.

Further studies have shown that for ceramic mixtures with cordierite powder as a basic component, the optimal ratio is higher and ranges from 0.30 to 0.36, while for the ceramic mixtures with hydro-aluminosilicate powder as a basic component the optimal binder/volume ratio range from 0.28 to 0.30. For ceramic mixtures with mullite-corundum powder as a basic component this ratio is the lowest one and ranges from 0.24 to 0.28. Thus, it was found that for each ceramic mixture there is an optimal binder/volume ratio. We explain this by the fact that for each ceramic mixture, depending on its component composition and adhesion properties, a certain amount of liquid is required (as in the traditional technology of ceramic products fabrication) to form a strong homogeneous structure and sufficient bond between the particles of the mixture. For each alternative mixture, this number should be set by direct experiment, within the range of 0.24 to 0.36. Correctly selected ratio allows increasing density up to 30% (from an average of 1.0 g/cm3 to 1.3 g/cm3) and compressive strength by 10-15 times (from 2-3 MPa to 30 MPa)

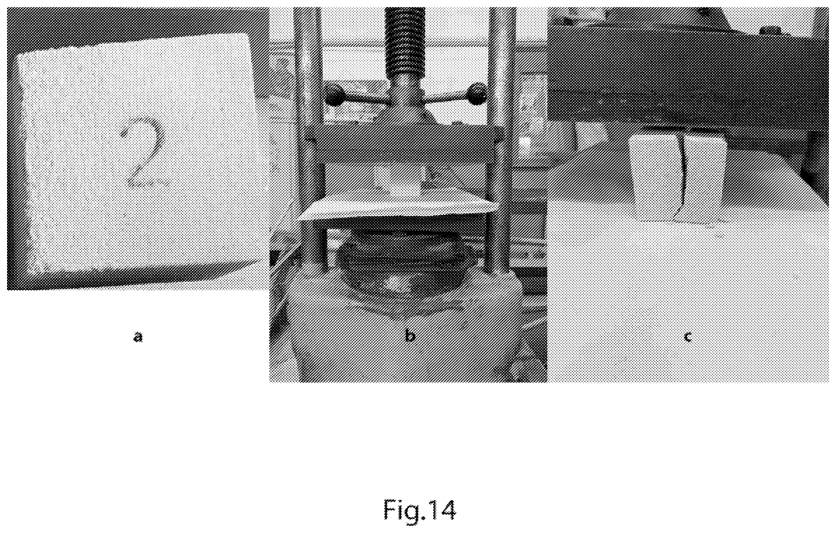

The layer spreading in the method of spreading ceramic powder by the shaft only from one side of the printing chamber results in poor distribution of the print media by the shaft on the printing surface. Thus, the printed objects have higher density areas closer to the feed chamber and much more scattered ceramic particle distribution at the far end of the printing chamber. With this way of spreading, bulk density of the print media (even in the areas closer to the feed chamber) remains too low. (FIG. 14a) demonstrates the distinction between two sides of the printed object: the spreading shaft moved from the right side in the left direction.

The problem can be solved by side alternation of the ceramic precursor powder spreading. Two opposing feeding chambers may be placed on opposite sides of the printing chamber. In this case, the spreading method is constructed in such a way that the spreading shaft deposits the volume of the ceramic precursor alternately from each feed chamber to the printing chamber. Each new layer, applied from the opposite side, compensates for the heterogeneity of the previous layer, thus maintaining the homogeneity of the structure of the printed product.

In the known prior art, the layer compaction step and the mechanism which allows to compress the sequential layers of ceramic precursor powder and a binder applied to it. However a layer of ceramic precursor powder moistened with a binder liquid is a very sticky substance and easily adheres to any smooth surface (which the described in U.S. Pat. No. 8,845,953B1 sealing platform is). Such effect was observed during the development of the method described herein, when the compression step went before the step of binder applying to the layer of ceramic precursor powder. Moreover, the additional mechanism greatly complicates the design of the application device, and the described process involves careful pressing of the applied layer, which cannot be done quickly enough and will significantly increase the application time of each layer.

These drawbacks may be avoided by running the compaction step before the binder step and using the spreading shaft for this purpose. The compaction procedure may be done while the shaft returns to its starting point of the current cycle after spreading the print media. The essence is that the shaft passes like a roller over a loose layer of print media and compresses it up to 2-2.5 times in volume. These actions lead to a noticeable increase in the density of both green and sintered bodies 1.5-2 times (from about 1.3 g/cm3 to about 2.8-3 g/cm3), depending on the degree of compaction (Table 3). Also, the described modification gave an increase in the strength of the sintered samples up to 2.5 times (from about 30 MPa to about 50-60 MPa), depending on the composition.

Different degrees of compaction were tested. Further measurements of the technical properties of the obtained samples showed that the powder dispersion and particle size distribution have a greater effect on the compression efficiency than the composition of the ceramic mixture. With the described above preferred particle size distribution, the maximum effective compression ratio is 2.5 times, at which the maximum values of density (about 3 g/cm3) and compressive strength (about 60 MPa) were reached. With more compression, particles of the compressed layer begin to affect the previous printed layer, shifting and destroying it, which leads to a loss in print quality. However, this parameter has no lower limit, since the compression procedure may not be used if the task is to obtain a high level of porosity (about 50-60%).

Achievement of these results allows us to assert that this technology can be applied for single and serial production of a wide range of products of complex, unique shape, in particular in such an area as surgical implants. Compressive strength up to 60 MPa, porous structure and printing accuracy meet all the requirements of this application.

### DETAILED DESCRIPTION

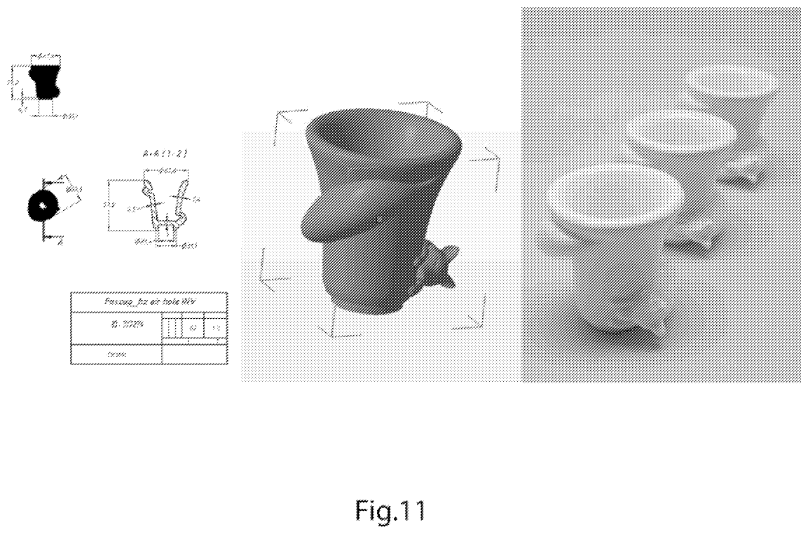

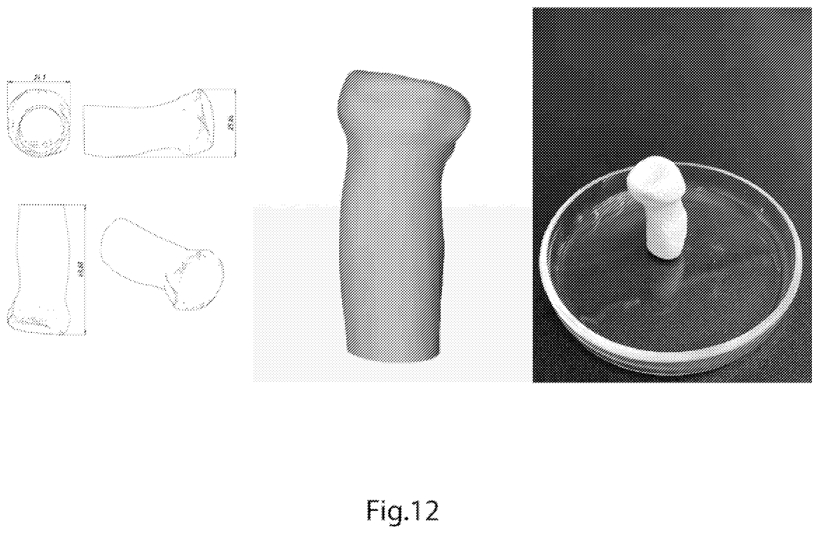

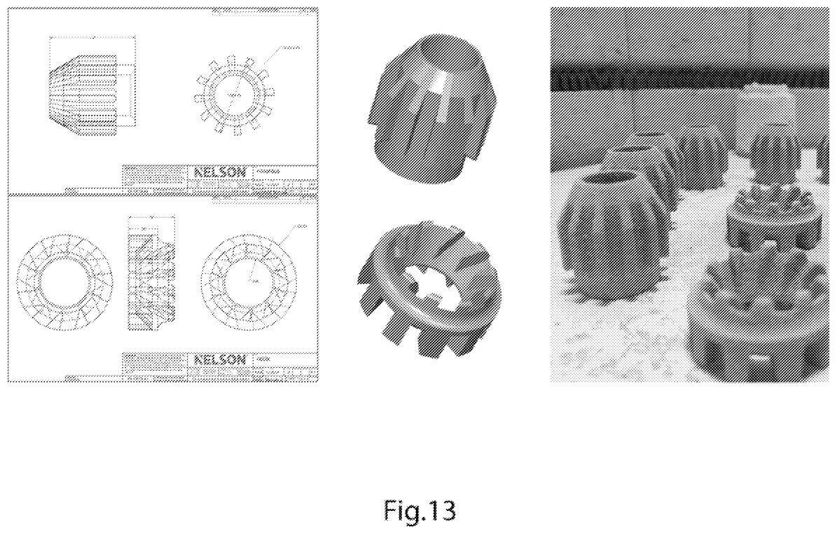

The present invention is intended for fabrication of various types of ceramic products for various purposes. The procedure described below is the result of long-term scientific theoretical and practical research and was developed based on the data of the tests carried out. The technology, through a wide range of adjustable settings, allows to control the technical properties of the resulting product, such as density and porosity, makes it possible to obtain ceramics significantly superior in strength to products obtained by alternative methods of additive manufacturing (including procedurally similar techniques mentioned in the previous sections). Advanced control of the technical properties of the finished product significantly expands the range of possible applications of the described invention and method, allowing the production of both highly porous samples of bone implants (FIG. 12) (medically tested for engraftment) and dense elements for technical purposes (FIG. 13) (such as welding ferrules), as well as models of decorative ceramics of complex shape (FIG. 11).

In addition to the above, the described device and method can be easily redirected to the production of other products (in particular, edible) by changing the composition of the binder and powder precursor.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

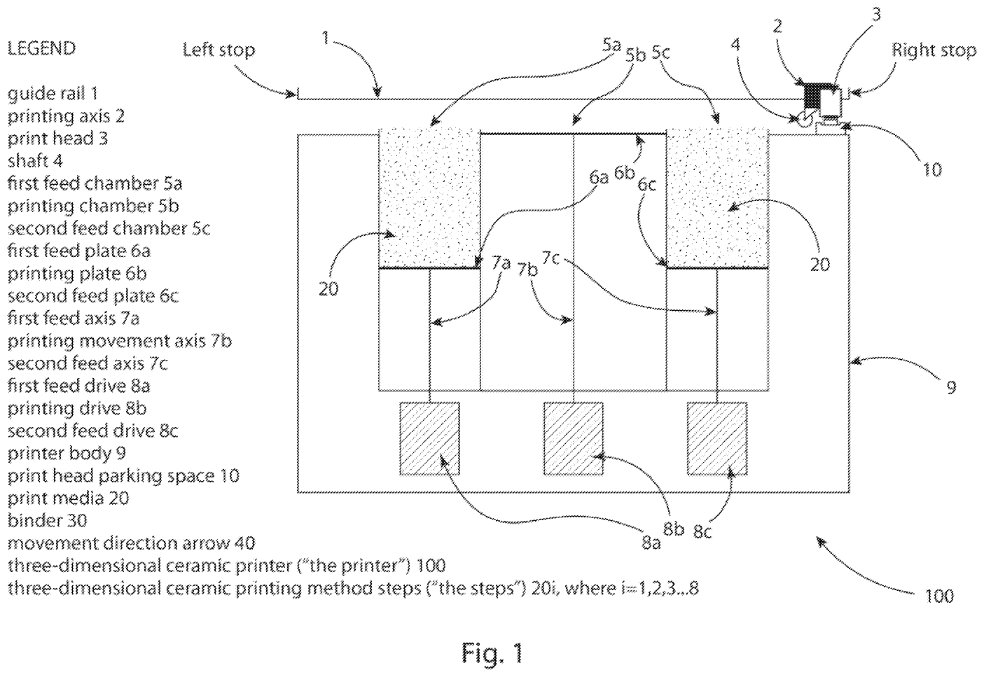

The present invention will now be described by example and through referencing the appended figures representing preferred and alternative embodiments. FIGS. 1-9 illustrate an example of a three-dimensional ceramic printer (“the printer”) 100 according to the preferred embodiment. In the preferred embodiment, the printer 100 may comprise a printer body 9 which may be attached to a printing chamber 5b. A printing plate 6b may be movable within the printing chamber 5b via a printing movement axis 7b and a printing drive 8b. A first feed chamber 5a and a second feed chamber 5c may be placed in the printer body 9 on opposing sides of the printing chamber 5b. A first feed plate 6a may be movable within the first feed chamber 5a via a first feed axis 7a and a first feed drive 8a, and a second feed plate 6c may be movable within the second feed chamber 5c via a second feed axis 7c and a second feed drive 8c. A guide rail 1 may be positioned above the chambers 5a, 5b, 5c, and a print head 3 may be movably attached to the guide rail 1 via a printing axis 2. A shaft 4 may be attached to the printing axis at the side of the print head 3. The feed chambers 5a, 5c, may each contain a volume of print media 20 and the shaft 4, may alternatingly deposit a volume of print media 20 from each feed chamber 5a, 5c, into the printing chamber 5b. Between the alternating deposits of print media 20, the print head 3 may be configured to deposit a volume of binder 30 onto desired portions of the print media 20 in the printing chamber 5b. In addition, the shaft 4 may be configured to compress each deposited layer of the print media 20, before the volume of binder deposition.

In the preferred embodiment, one or more other elements of the printer 100 may be attached to printer body 9. Preferably, the chambers 5a, 5b, 5c and the drives 8a, 8b, 8c, may be housed within the printer body 9 and the guide rail 1 may be attached to the printer body 9 above the chambers 5a, 5b, 5c. In the preferred embodiment, the printer body 9 may be configured with a generally rectangular prism shape, although the printer body 9 may be configured in any shape and size. The printer body 9 may comprise substantially rigid materials such as steel alloys, aluminum, aluminum alloys, copper alloys, other types of metal or metal alloys, various types of hard plastics, such as polyethylene (PE), Ultra-high-molecular-weight polyethylene (UHMWPE, UHMW), polypropylene (PP) and polyvinyl chloride (PVC), polycarbonate, nylon, Polymethyl methacrylate (PMMA) also known as acrylic, melamine, hard rubbers, fiberglass, carbon fiber, resins, such as epoxy resin, wood, other plant based materials, or any other material including combinations of materials that are substantially rigid and suitable for securing and positioning one or more elements of the printer 100.

In the preferred embodiment, a printing chamber 5b may be positioned generally centrally within the printer body 9. A printing chamber 5b may be configured in any shape and size. Generally, the printing chamber 5b may be made from or comprise a substantially rigid material and may form a container into which print media 20 and binder 30 may be deposited to form a ceramic object. A printing plate 6b may be placed within the printing chamber 5b and shaped to contact walls forming the vertical portions of the printing chamber 5b. In the preferred embodiment, a printing chamber 5b may comprise a generally rectangular prism shape having four vertical walls and a printing plate 6b may comprise a printing chamber shape which may contact the walls to prevent print media 20 from falling past the printing plate 6b.

The printing plate 6b may be moved vertically within the printing chamber 5b via a printing movement axis 7b which may be operably attached to a printing drive 8b. A printing drive 8b may comprise an actuator or mechanism which is capable of moving or transferring movement to the printing movement axis 7b, and a printing movement axis 7b may comprise a linkage or device which may be used to control the position of the printing plate 6b within the printing chamber 5b, such as by transferring the mechanical energy from a printing drive 8b to a printing plate 6b to raise and lower the printing plate 6b. A printing drive 8b may comprise a comb drive, solenoid, electric motor, hydraulic cylinder, pneumatic actuator, servomechanism, screw jack, or any other type of hydraulic, pneumatic, electric, mechanical, thermal, magnetic type of actuator, or any other type of actuator. A printing movement axis 7b and a printing drive 8b may be made from or comprise a substantially rigid material.

In the preferred embodiment, the printer 100 may comprise a first feed chamber 5a and a second feed chamber 5c which may be made from or comprise a substantially rigid material and may be positioned on opposing sides of the printing chamber 5b. In other embodiments, the printer 100 may comprise a first feed chamber 5a, a second feed chamber 5c, a third feed chamber, a fourth feed chamber, or any other number of feed chambers which may be positioned generally opposingly and/or peripherally around the printing chamber 5b. A feed chamber 5a, 5c, may be configured in any shape and size. Generally, a feed chamber 5a, 5c, may form a container into which print media 20 may be stored prior to being deposited into a printing chamber 5b. A feed plate 6a, 6c, may be placed within each feed chamber 5a, 5c, and shaped to contact the one or more walls forming the vertical portions of the respective feed chamber 5a, 5c. In preferred embodiments, a feed chamber 5a, 5c, may comprise a generally rectangular prism shape having four vertical walls and a feed plate 6a, 6c, may comprise a complementary rectangular shape which may contact the walls to prevent print media 20 from falling past the feed plate 6a, 6c.

A feed plate 6a, 6c, may be moved vertically within its respective feed chamber 5a, 5c, via a respective feed axis 7a, 7c, which may be operably attached to a respective feed drive 8a, 8c. Similar to a printing drive 8b, a feed drive 8a, 8c, may comprise an actuator or mechanism which is capable of moving or transferring movement to its respective feed axis 7a, 7c, and a feed axis 7a, 7c, may comprise a linkage or device which may be used to control the position of a respective feed plate 6a, 6c, within its respective feed chamber 5a, 5c, such as by transferring the mechanical energy from a feed drive 8a, 8c, to a feed plate 6a, 6c to raise and lower the feed plate 6a, 6c. A feed drive 8a, 8c, may comprise a comb drive, digital micromirror device, solenoid, electric motor, electroactive polymer, hydraulic cylinder, piezoelectric actuator, pneumatic actuator, servomechanism, thermal bimorph, screw jack, or any other type of hydraulic, pneumatic, electric, mechanical, thermal, magnetic type of actuator, or any other type of actuator.

A guide rail 1 may comprise a structure which may be suitable for supporting a print head 3, printing axis 2, and shaft 4. Generally, a printing axis 2 may be movably attached to the guide rail 1 so that the printing axis 2 may move along the guide rail 1 to position the print head 3 and shaft 4, above desired portions of the chambers 5a, 5b, 5c. A feed drive 8a, 8c, may comprise a comb drive, digital micromirror device, solenoid, electric motor, electroactive polymer, hydraulic cylinder, piezoelectric actuator, pneumatic actuator, servomechanism, thermal bimorph, screw jack, or any other type of hydraulic, pneumatic, electric, mechanical, thermal, magnetic type of actuator, or any other type of actuator.

The printer 100 may comprise a print head 3 which may be configured to deposit binder 30 onto print media 20 which is placed in the printing chamber 5b. A print head 3 may be moved via a printing axis 2 to deposit a layer of binder 30 onto a first layer of print media 20 in the printing chamber 5b and a second layer of print media 20 deposited onto the layer of binder 30 may be adhered to the first layer of print media 20 by the binder 30. Successive layers of print media 20 and binder 30 may be built up to produce a desired object in the printing chamber 5b. Preferably, a print head parking space 10 may be placed in the printer body 9 which may form a platform upon which portions of the print head 3, printing axis 2, and/or shaft 4, may be supported when not in use. Optionally, the print head parking space 10 may be configured to perform cleaning functions on the print head 3, printing axis 2, and/or shaft 4.

The printer 100 may comprise one or more shafts 4, which may be configured to move print media 20 from a feed chamber 5a, 5c, and into the printing chamber 5b or to compress the layer of print media 20 in the printing chamber 5b. In preferred embodiments, a shaft 4 may comprise a generally cylindrical roller having a length greater than or equal to the length of the chambers 5a, 5b, 5c. In this manner, as the shaft 4, is moved over a feed chamber 5a, 5c, it may push, roll, or otherwise move print media 20 into the printing chamber 5b. The shaft 4 may be configured to rotate in a clockwise or counterclockwise manner as it is moved across the chambers 5a, 5b, 5c, via the printing axis 2.

Print media 20 may comprise a ceramic powder, however, the printer 100 is not limited to a certain type of ceramic powder. In the preferred embodiment, the print media 20 consists of the materials described in previous sections. Binder 30 may comprise a liquid ceramic binder. In the preferred embodiment, a binder 30 may comprise an aqueous ethylene glycol based liquid ceramic binder described in previous sections.

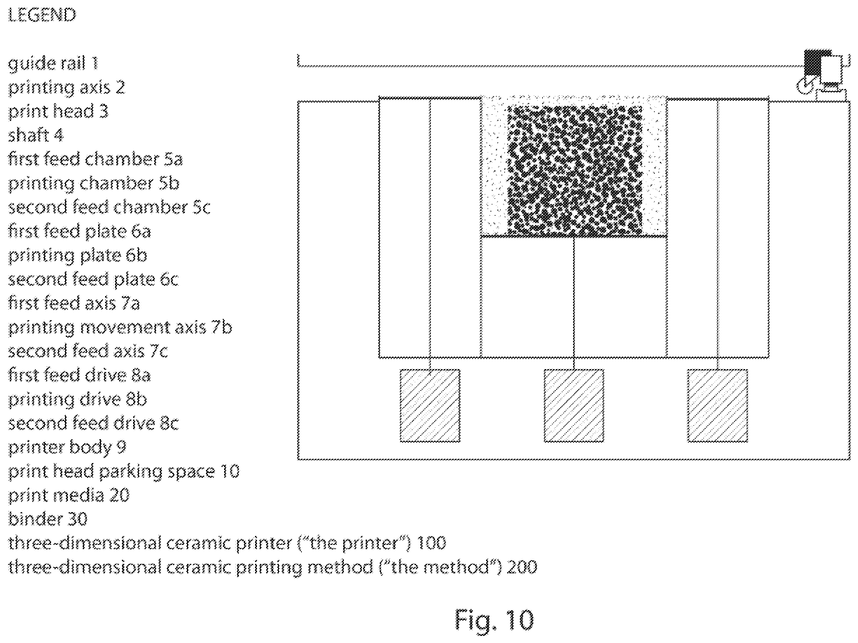

FIG. 10 depicts a block diagram of an example of a method for three-dimensional ceramic printing (“the method”) 200 according to the preferred embodiment described herein. Steps of the method 200 may be performed by a printer 100 having a volume of print media 20 placed in a first feed chamber 5a and having another volume of print media 20 placed in a second feed chamber 5c with the printhead 3 in communication with a source of binder 30. The printer 100 may comprise a first feed chamber 5a positioned on one side of the printing chamber 5b, such as the left side, and a second feed chamber 5c positioned on an opposing side of the printing chamber 5b, such as the right side. The method 200 may be used to form an object by sequentially layering print media 20 and binder 30 together resulting in an object formed by a plurality of print media 20 layers and binder 30 layers. Prior to the start of the method 200, the printing axis 2 may be placed in print head parking space 10 (as shown in FIGS. 1,2) and/or the printing axis 2 may be moved or positioned behind the first feed chamber 5a (as shown in FIGS. 1,2). As an example, herein the procedure will be considered starting from the right feed chamber 5c (at the “right stop” point closer to the print head parking space 10).

The lifting/lowering values of the printing 6b and feeding 6a,6d plates along the respective 7b and 7a,7d axes depend on the areas of the feeding 5a,5c and printing 5b chambers. The appropriate feed plate should be raised to a height that allows sufficient volume of the print media 20 to be displaced to cover the entire print chamber 5b, taking into account the amount of subsequent compaction of the applied layer. The volume of print media 20, deposited from the feed chambers 5a,5c, should exceed the final layer volume, calculated as: layer volume=layer thickness*print chamber area, several times, depending on the properties of print media 20 and the specified degree of layer-by-layer compaction.

Layer thickness may take values from 50 to 200 microns, but 100 microns is preferred. Such a thickness allows to achieve sufficient smoothness of the surface of the final product, while at a thickness below 50 microns printing takes much longer, without a significant improvement in quality, and above 200 microns the layers become noticeable on the surface. In addition, with a layer thickness below than 50 microns, binder droplets often soak deeper than the current layer and affect layers below, and a thickness above than 200 microns is too large for a high-quality layer-by-layer connection within the green body.

The ratio of the binder 30 volume to the volume of the print media 20 to be bonded (“Binder/Volume ratio”) may take values from 0.24 to 0.36 according to the kind of print media 20 used. At lower values, the substance is not enough for high-quality bonding of particles of print media 20, while at higher values during the printing process the binder 30 soaks into the next layers and beyond the print spot due to capillary forces, thus the “excess” amount of print media 20 sticking, which is difficult to remove later during the dedusting process.

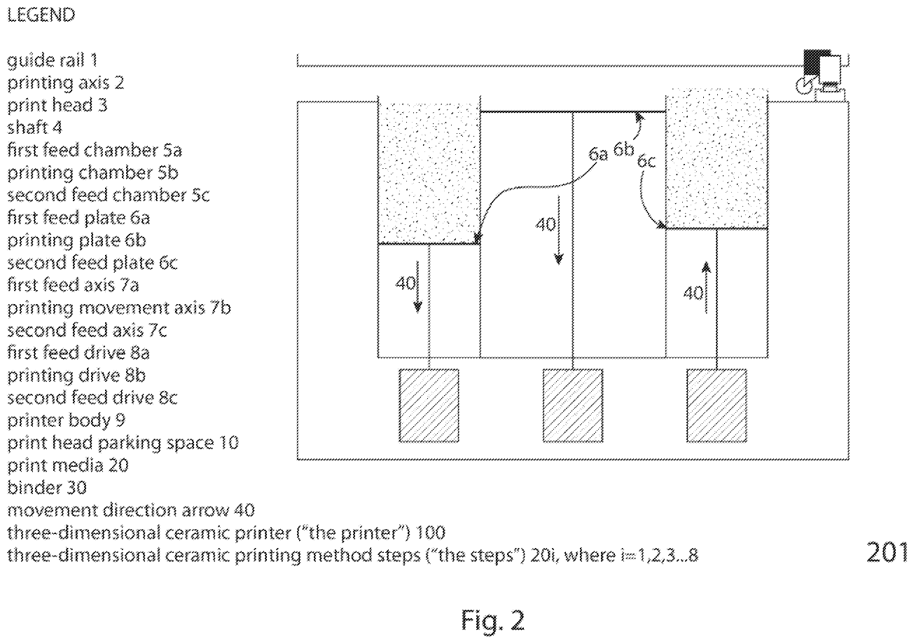

The method 200 may start the 201 step when the printing axis 2 is at the “right stop” point and the printing plate 6b is lowered by the layer thickness+the thickness of its compaction (usually this is a certain percentage of the layer thickness, but not more than 200%). The second feed plate 6c may be raised by the value, calculated from the above considerations and the first feed plate 6a may be lowered by the value sufficient for receiving the surplus of print media 20. The movement may take place simultaneously. (as shown in FIG. 2).

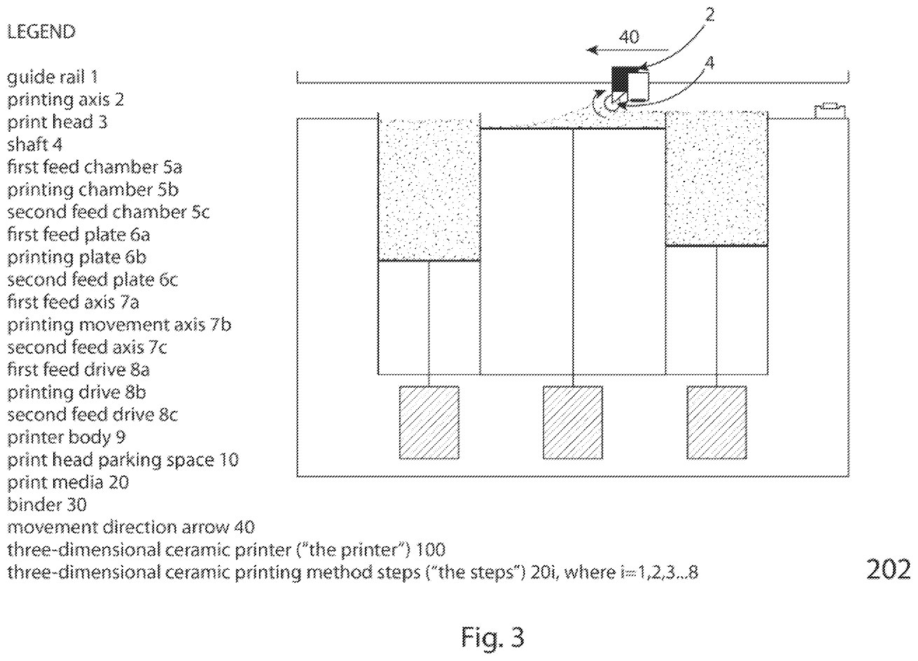

In step 202, print media 20 from the second feed chamber 5c may be deposited onto the printing plate 6b in the printing chamber 5b (as shown in FIG. 3). The shaft 4 rotation drive starts rotating the shaft clockwise and the shaft reaches its maximum rotation speed. The printing axis 2 moving drive starts translational movement along the guide rail 1 towards “left stop.” The printing axis 2 moving drive stops the movement of the printing axis 2 at the “left stop” point above the first feed plate 6a, the shaft 4 rotation drive stops the rotation of the shaft 4. In this manner the raised layer of print media 20 from the second feed chamber 5c forms a first layer of print media 20 (to which binder 30 may be applied) in the printing chamber 5b. In some embodiments, the shaft 4 may rotate or spin counterclockwise, as printing axis 2 moves across the second feed chamber 5c towards the first feed chamber 5a.

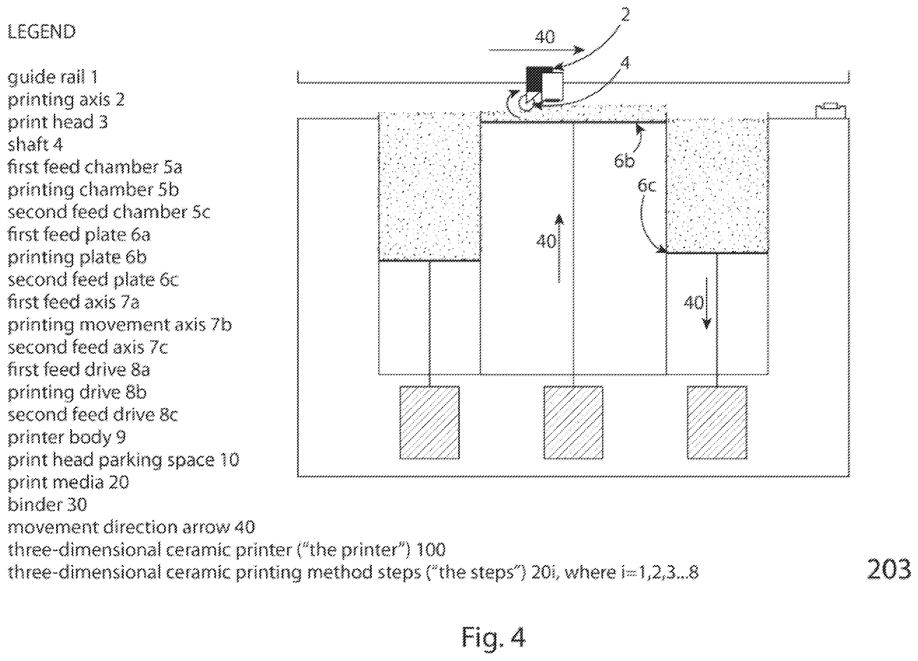

In step 203, the layer of print media 20, spread in the previous step, may be compacted by a certain percentage, defined earlier. The second feed plate 6c may be lowered by the value sufficient for receiving the surplus of print media 20 after layer compaction, the printing plate 6b should be raised by the thickness of layer compaction. The movement may take place simultaneously. The shaft 4 rotation drive starts the shaft clockwise rotation and the shaft 4 reaches its appropriate rotation speed. The rotation frequency of the shaft 4 may match the printing axis 2 translational movement speed to avoid slipping or gliding. The printing axis 2 moving drive starts translational movement (FIG. 4) along the guide rail 1 towards “right stop”. The printing axis 2 moving drive stops the movement of the shaft 4 at the “right stop” point, the shaft 4 rotation drive stops the rotation of the shaft 4. In this manner the loose layer of print media is compacted into a denser state. In some embodiments, the shaft 4 may rotate or spin counterclockwise, as printing axis 2 moves across the first feed chamber 5a towards the second feed chamber 5c.

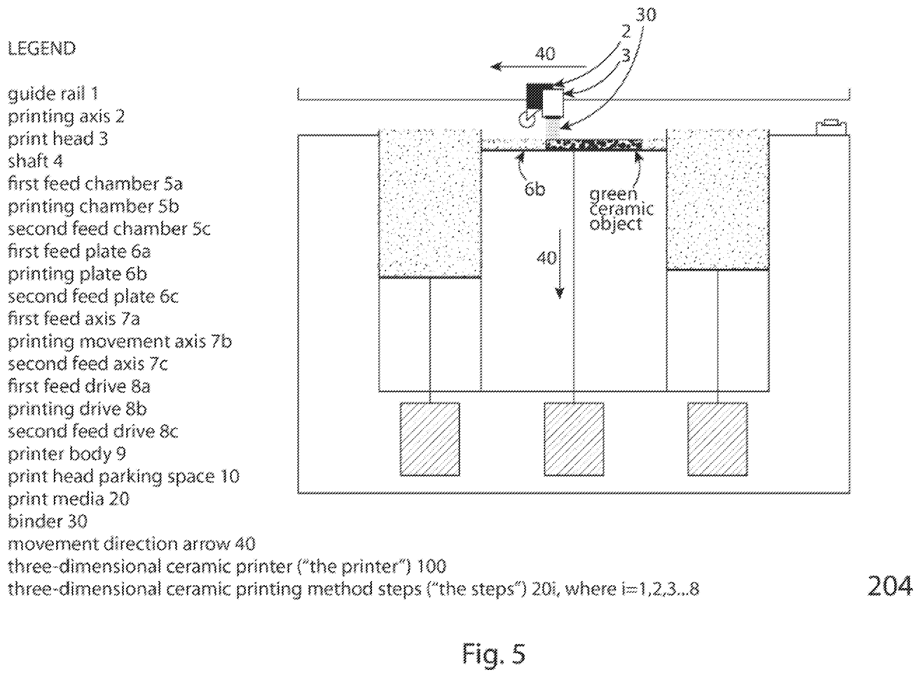

In step 204, binder 30 may be deposited onto desired portions of the print media 20 layer in the printing chamber 5b by the printhead 3 (as shown in FIG. 5). The printing plate 6b may be lowered by the layer thickness+the thickness of its compaction, counting from the previous position height. The printing axis 2 moving drive starts translational movement along the guide rail 1 towards “left stop”. The printing axis 2 may be moved across the printing chamber 5b in both directions and the printhead 3 drive may move the printhead 3 along the printing axis 2 in both directions to allow the printhead 3 to apply strips or rows of binder 30 on the print media 20 layer in a similar manner as an inkjet printer prints an image on paper. During this movement binder 30 may be deposited onto desired portions of the print media 20 layer in the printing chamber 5b by the printhead 3 according to the Binder/Volume ratio described above. Optionally, the printing axis 2 may return to the print head parking place 10 (as shown in FIGS. 1,2). When the required amount of binder 30 is applied to the printable area, the printing axis 2 moving drive stops the movement of the printing axis 2 at the “left stop” point above the first feed plate 6a

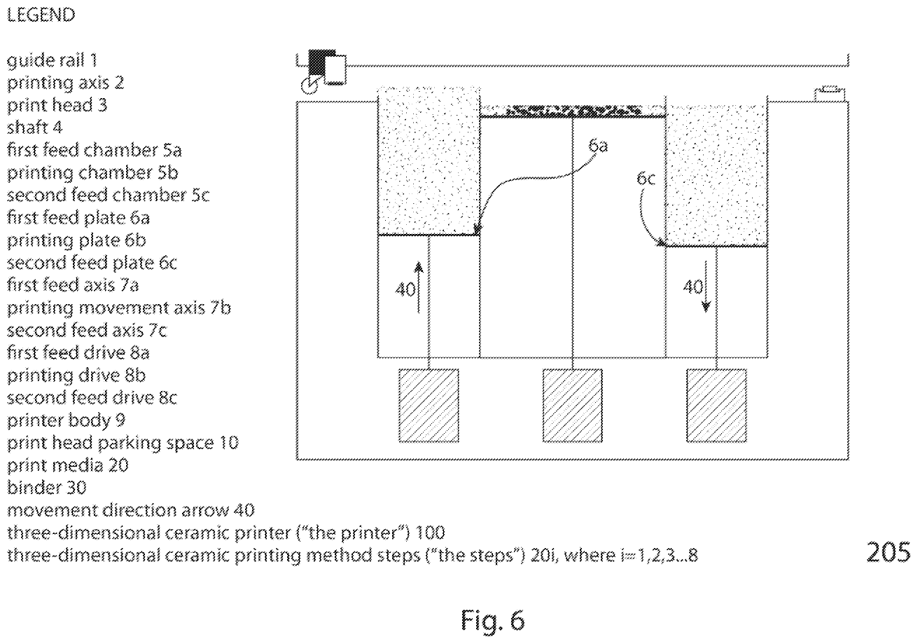

The step 205 may start when the printing axis 2 is at the “left stop” point. The first feed plate 6a is raised by the value calculated from the above considerations, the second feed plate 6c is lowered by the value sufficient for receiving the surplus of print media 20 (FIG. 6). The movement may take place simultaneously.

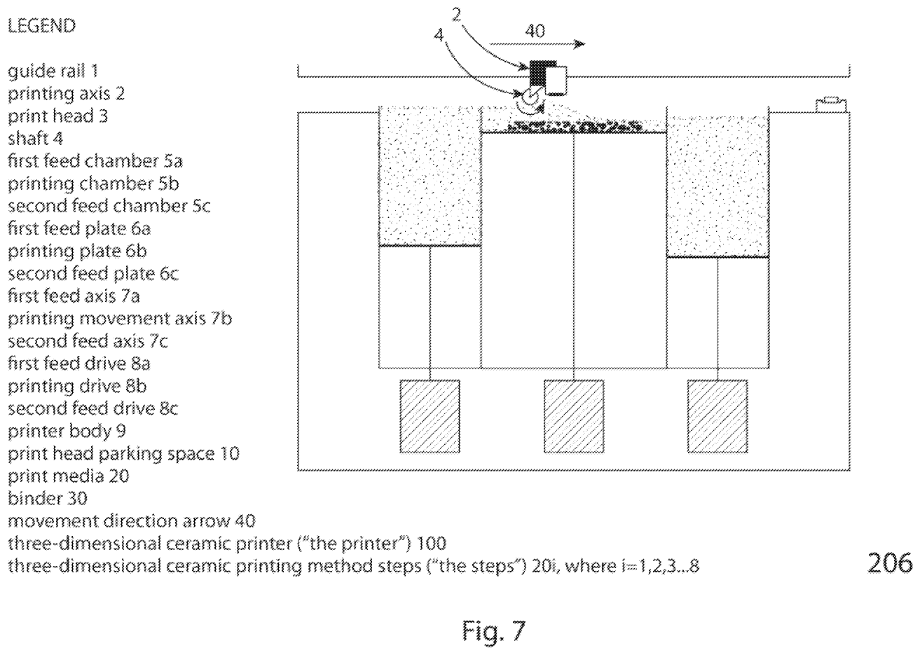

In step 206, print media 20 from the first feed chamber 5a may be deposited onto the binder 30 and print media 20 on the printing plate 6b in the printing chamber 5b (as shown in FIG. 7). The shaft 4 rotation drive starts rotating the shaft counterclockwise and the shaft reaches its maximum rotation speed. The printing axis 2 moving drive starts translational movement along the guide rail 1 towards “right stop”. The printing axis 2 moving drive stops the movement of the printing axis 2 at the “right stop” point above the second feed plate 6c, the shaft 4 rotation drive stops the rotation of the shaft 4. In this manner the raised layer of print media 20 from the first feed chamber 5a forms a second layer of print media 20 (to which binder 30 may be applied) in the printing chamber 5b. In some embodiments, the shaft 4 may rotate or spin clockwise, as printing axis 2 moves across the first feed chamber 5a towards the second feed chamber 5c.

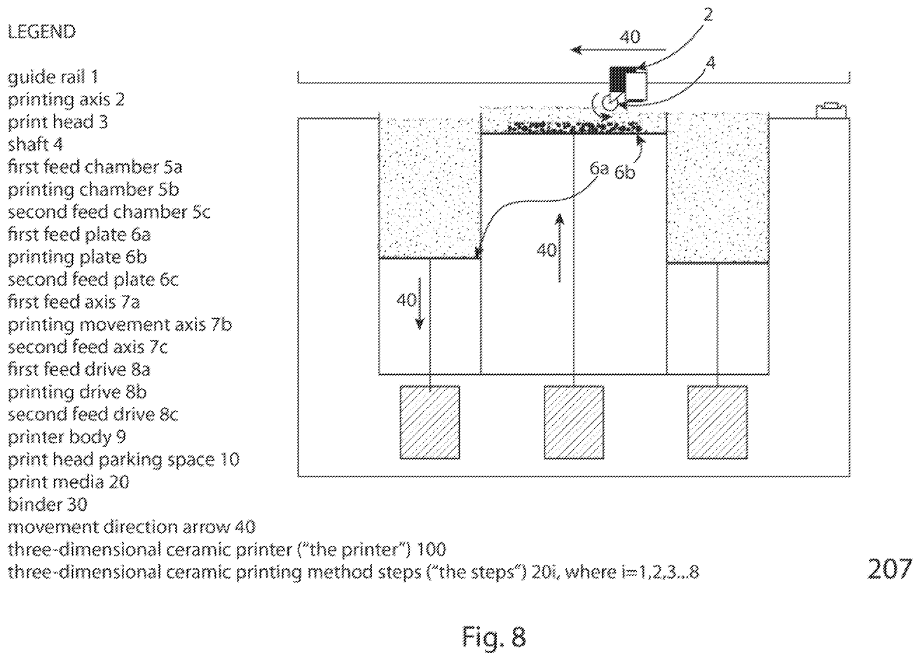

In step 207, the second layer of print media 20, spread in the previous step, may be compacted by a certain percentage, defined earlier (FIG. 8). The first feed plate 6a may be lowered by the value sufficient for receiving the surplus of print media 20 after layer compaction, the printing plate 6b should be raised by the thickness of layer compaction. The movement may take place simultaneously. The shaft 4 rotation drive starts the shaft counterclockwise rotation and the shaft 4 reaches its appropriate rotation speed. The rotation frequency of the shaft 4 should match the printing axis 2 translational movement speed to avoid slipping or gliding. The printing axis 2 moving drive starts translational movement along the guide rail 1 towards “left stop”. The printing axis 2 moving drive stops the movement of the shaft 4 at the “left stop” point, the shaft 4 rotation drive stops the rotation of the shaft 4. In this manner the loose layer of print media is compacted into a denser state. In some embodiments, the shaft 4 may rotate or spin clockwise, as printing axis 2 moves across the second feed chamber 5c towards the first feed chamber 5a.

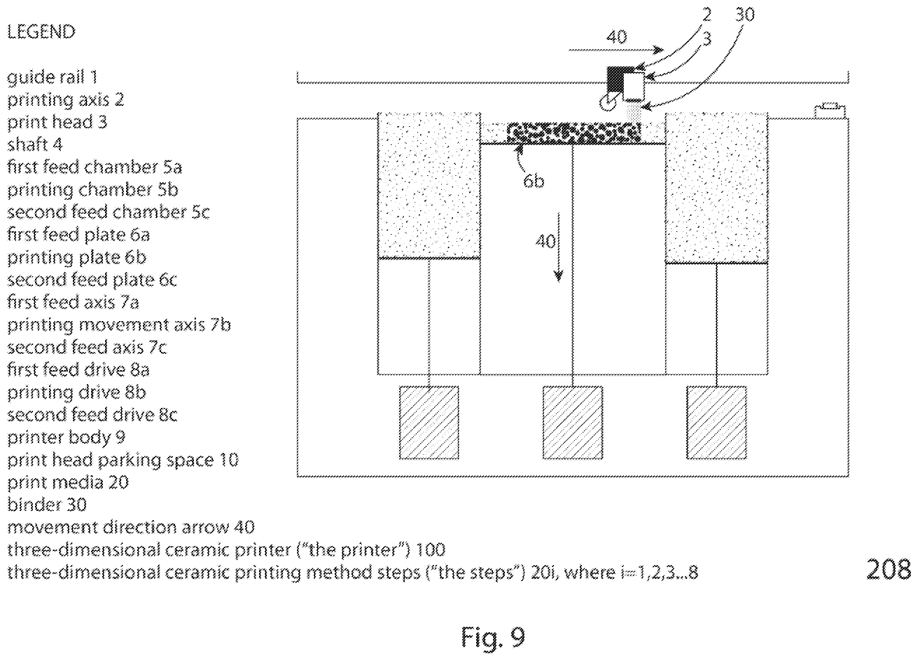

In step 208, binder 30 may be deposited onto desired portions of the print media 20 layer in the printing chamber 5b by the print head 3 (as shown in FIG. 9). The printing plate 6b may be lowered by the layer thickness+the thickness of its compaction, counting from the previous position height. The printing axis 2 moving drive starts translational movement along the guide rail 1 towards “right stop”. The printing axis 2 may be moved across the printing chamber 5b in both directions and the printhead 3 drive may move the printhead 3 along the printing axis 2 in both directions to allow the printhead 3 to apply strips or rows of binder 30 on the print media 20 layer in a similar manner as an inkjet printer prints an image on paper. During this movement binder 30 may be deposited onto desired portions of the print media 20 layer in the printing chamber 5b by the print head 3 according to the Binder/Volume ratio described above. Optionally, the printing axis 2 may return to the print head parking place 10 (as shown in FIGS. 1,2). When the required amount of binder 30 is applied to the printable area, the printing axis 2 moving drive stops the movement of the printing axis 2 at the “right stop” point above the second feed plate 6c. After step 208, the method 200 may continue to step 201 until a plurality of layers of print media 20 and binder 30 are formed in the printing chamber 5b.

In some embodiments the method 200 may finish 208. In the preferred embodiment the printed green object may be covered with a number of layers of not compacted ceramic powder precursor (FIG. 10) by repeating steps sequence 201-202-205-206 starting from any of them (depending on the printhead end point after the final printed layer). This procedure aims to level the intensity of the top and the bottom sides drying of the printed object. After the method 200 the print media 20 may be removed from the printing chamber 5b and any print media 20 not bound together with binder may be easily removed to leave behind the desired object formed of a plurality of print media 20 and binder 30 layers.

While some exemplary shapes and sizes have been provided for elements of the printer 100, it should be understood to one of ordinary skill in the art that the guide rail 1, printing axis 2, print head 3, shaft 4, chambers 5a, 5b, 5c, plates 6a, 6b, 6c, axes 7a, 7b, 7c, drives 8a, 8b, 8c, printer body 9, print head parking space 10, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, the elements that comprise the printer 100 may be made from durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the printer 100 may be attached or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the printer 100 may be attached or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the printer 100 may be attached by being one of connected to and integrally formed with another element of the printer 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

### Tests and Results

Binder/volume ratio for cordierite ceramic composition was found during work on printing of real objects, in particular, stud welding ferrules from it. A consistent change in the ratio of binder to volume showed that in the range from 0.20 to 0.29, the amount of binder was not enough for bonding of the cordierite powder particles, and even when printed with compaction, green samples were fragile and crumbled in hands. In FIG. 16a, you can see that for some objects the upper part is shifted as if it was cut off with a knife. This was due to the fact that the binder did not bind the layers of compacted cordierite powder tightly enough.

At the same time, the ratio of binder to volume corresponding to values between 0.37 and 040 was found to be too high for printing from cordierite ceramic mixture. Green samples were hard, the adhered powder on the sides could be easily brushed off with a toothbrush, while the product was not deformed, i.e. the strength achieved was already enough. Nevertheless, it can be seen on FIG. 16b that there was a lot of adhered powder on the bottom of the product, which was difficult to clean off (practically not cleaned off because it actually makes up one piece with the product), so it was difficult to determine the desired boundaries of a real object. Thus, it was found that the ideal ratio of binder to volume for cordierite ceramic mixture is between 0.30 and 0.36. Objects printed at this ratio (FIG. 16c) were strong enough (Table 3), while non-binded powder particles were easily removed from the surface.

A large number of experiments were carried out to confirm the effectiveness of the developed 3D printer concept and printing method. To this end, test samples, printed on a preferred embodiment of the printer using the described method and in accordance with the mentioned technical parameters, were tested under laboratory conditions for such basic characteristics as density, shrinkage and ultimate compressive strength. The shape of the test sample was a cube with a facet length of 50 mm (FIG. 14) and was chosen to allow all three test characteristics to be measured. In addition, the chosen shape of the test sample allowed for the study of the change in the degree of shrinkage with height, an important detail has not been paid attention to in any of the previous studies and patents. For this purpose, the upper and lower overall dimensions of the test cube were measured (here the definition of the mentioned dimensions is referred to the position of the test sample in the print chamber). Both green and sintered samples were tested.

All ceramic products experience shrinkage both after drying and after firing. In the process of drying, the moisture that occupied the volume between the ceramic particles evaporates and the ceramic particles, taking its place, are pulled together. Then, in the process of firing, with increasing temperature, the density of the object increases, the particles are compressed, pulling together, some components melt, spilling between other ceramic particles, which contributes to additional convergence. The greater the shrinkage of the sample during the described processes, the more it deforms, in places of deformation excessive stresses arise, leading to cracks and destruction of the product. Therefore, when developing a method for the production of ceramic products, significant efforts are aimed at reducing the shrinkage of the ceramic material both by introducing auxiliary components (a filler that reduces shrinkage) and by introducing additional procedures (such as compaction). In addition, in the additive manufacturing of ceramics, it is difficult to achieve a homogeneous product in height during layer-by-layer application and binding of layers. So usually the lower part is wetted more due to the leakage of the binder from the higher layers of ceramic powder to the lower ones. This results in varying degrees of shrinkage at the top and bottom of the product.

By the method of successively increasing the volumetric content of the binder with a constant degree of compaction, to level the shrinkage dependency of height and to achieve the minimum possible shrinkage of the printed green and sintered test samples, without loss in the surface properties of the product. Then to compare the results with those, received by printing without compaction. Each time 4 twin samples were printed (i.e. samples with completely identical powder composition, technology of execution in accordance with the technical specification) with the corresponding ratio of binder/volume (4 with the binder/volume ratio of 0.1, 4—with 0.2 and 4—with 0.3, 12 samples in total). After each printing of samples with certain settings, the lower and upper sections were measured.

A caliper was used to measure shrinkage and the measurements are accurate to within +/−0.01 mm. Each sample was measured along the upper and lower perimeter, the data obtained were entered into the table. Then the average values of each cube dimension were calculated and on their basis the shrinkage of green and sintered samples in comparison with a given model of 50 mm in size was calculated. The first and the second side of the top or bottom perimeter are marked by letters “a” and “b” in the table. It can be seen that at the maximum compression ratio and the optimal ratio of the binder to the volume (0.3), the minimum shrinkage values were achieved (about 2%), and the difference in the shrinkage of the upper and lower perimeters was practically leveled.

Also from FIG. 15, it can be seen that with increasing binder/volume ratio, shrinkage increased in samples printed without compaction and decreased in samples printed with compaction. This is due to the significantly higher density of compacted samples. In the process of printing, the layers are so compacted that the excess of the binder, which has not found a place in the structure of the product, spreads evenly in all directions by a small amount, proportionally increasing the area of the print spot. The higher the ratio of the binder to the volume of the ceramic powder, the more the print spot increases. In this way, future shrinkage of the product is compensated for by scaling it during printing. At the same time, samples printed without compaction have a high porosity and easily absorb moisture, therefore, the more moisture, the more shrinkage will be during the drying process (as mentioned above).

Below are tables showing the results of measurements of density, shrinkage and compressive strength of test samples fabricated from one of our hydro-aluminosilicate compositions. This material was selected for testing because it is used in one of the promising areas of application of the proposed device and method, namely, for the creation of bone implants. Porosity values were not measured for the tested samples. However, the bulk density of the samples indicates a low level of porosity. Taking into account the importance of this characteristic for the aforementioned field of application, the porosity value can easily be increased without loss in strength to 60-70% by adding the proportion of water-insoluble polymers to the composition of the ceramic precursor mixture, as mentioned above.

TABLE 1
Shows shrinkage (%) based on b/v ratio for green and sintered samples.

| | | BINDER/ | | | | | | | | | | |
|---|---|---|---|---|---|---|---|---|---|---|---|---|
| | COMPACTION | VOLUME | | 1 | | 2 | | 3 | | 4 | | SHRINKAGE |
| | DEGREE | RATIO | | A | B | A | B | A | B | A | B | (%) |
| GREEN | 2.5 | 0.1 | TOP | 48.41 | 48.13 | 48.58 | 48.79 | 48.86 | 48.51 | 48.72 | 48.99 | −2.75 |
| | | | BOTTOM | 48.8 | 49.28 | 49.08 | 49.24 | 49.42 | 49.45 | 49.6 | 49.3 | −1.46 |
| | | 0.2 | TOP | 49.58 | 49.83 | 49.46 | 49.39 | 49.54 | 49.89 | 49.69 | 49.87 | −0.69 |
| | | | BOTTOM | 49.63 | 49.74 | 49.71 | 49.65 | 50.03 | 49.61 | 50.02 | 49.83 | −0.45 |
| | | 0.3 | TOP | 49.77 | 49.98 | 49.78 | 49.99 | 49.88 | 50.22 | 49.78 | 49.86 | −0.19 |
| | | | BOTTOM | 49.65 | 49.93 | 50.09 | 50.07 | 50.03 | 50.3 | 50.05 | 49.68 | −0.05 |
| SINTERED | 2.5 | 0.1 | TOP | 47 | 46.56 | 47.14 | 47.17 | 47.21 | 47.12 | 46.72 | 47.33 | −5.94 |
| | | | BOTTOM | 47.81 | 48.22 | 48.12 | 48.25 | 48.29 | 48.48 | 48.3 | 47.85 | −3.67 |
| | | 0.2 | TOP | 48.5 | 48.55 | 48.22 | 48.14 | 48.34 | 48.48 | 48.74 | 48.74 | −3.07 |
| | | | BOTTOM | 48.71 | 48.77 | 48.57 | 48.61 | 48.65 | 48.85 | 48.82 | 48.59 | −2.61 |
| | | 0.3 | TOP | 48.85 | 48.93 | 48.93 | 49.02 | 49.03 | 49.22 | 48.79 | 49.01 | −2.05 |
| | | | BOTTOM | 49 | 48.8 | 49.42 | 49.28 | 49.21 | 49.45 | 49.13 | 48.47 | −1.81 |

Density and strength are substantial technical characteristics for a product made of any material, and for ceramic products in particular. Their values are important both for decorative ceramics (to a lesser extent) and for technical ceramics, some applications of which require the product to withstand heavy loads. It is noted that the indicators of technical ceramics produced by pressing (compressive strength 300-500 MPa and density 5-6 g/cm³) are unattainable in alternative technologies; however, for some areas of application, it is possible to achieve high results using the developed method of additive manufacturing.

The objective of the tests: by the method of successively increasing the volumetric content of the binder with a constant degree of compaction, to achieve the maximum possible density and strength of the printed green and sintered test samples, without loss in the surface properties of the product. Each time 4 twin samples were printed (i.e. samples with completely identical powder composition, technology of execution in accordance with the technical specification) with the corresponding ratio of binder/volume (4 with the binder/volume ratio of 0.1, 4—with 0.2 and 4—with 0.3, 12 samples in total).

To calculate the bulk density, all green and sintered test samples were measured in height, and the data on the upper and lower dimensions were averaged, which made it possible to calculate the volume with sufficient accuracy. A caliper was used to measure height and the measurements are accurate to within +/−0.01 mm. Then all test samples were weighed on a balance with an error of +/−5 g. The data obtained were recorded in a table. Obviously, at a maximum compaction of 2.5 times, the density of both green and sintered samples did not change intensively, even taking into account a rather large difference in the binder/volume ratio.

A laboratory press with a pressure gauge was used to measure the ultimate compressive strength. All samples, both green and sintered, withstood the load well and broke with one crack in the center like concrete (FIG. 14c). From the data entered in the table it can be seen that, in contrast to the density, which at the maximum degree of compaction changed very insignificantly with an increase in the binder/volume ratio, the same cannot be said about the compressive strength. Ultimate compressive strength increased significantly, which indicates a greater homogeneity of the structure with a higher binder/volume ratio, as well as better particle bonding and better sintering.

TABLE 2
Compaction degree and b/v ratio for each of green and sintered sample.

| | | BINDER/ | | | | | | | | | | |
|---|---|---|---|---|---|---|---|---|---|---|---|---|
| | COMPACTION | VOLUME | | 1 | | 2 | | 3 | | 4 | | AVERAGE |
| | DEGREE | RATIO | | A | B | A | B | A | B | A | B | VALUE |
| GREEN | 2.5 | 0.1 | A B, MM | 48.61 | 48.71 | 48.83 | 49.02 | 49.14 | 48.98 | 49.16 | 49.15 | |
| | | | H, MM | 48.66 | | 48.92 | | 49.06 | | 49.15 | | |
| | | | V, CM3 | 115.18 | | 117.09 | | 118.08 | | 118.75 | | |
| | | | M, G | 300.00 | | 305.00 | | 305.00 | | 310.00 | | |
| | | | P, G/CM3 | 2.6046 | | 2.6048 | | 2.5830 | | 2.6105 | | 2.60 |
| | | | L, MPA | 3.4947 | | 3.2477 | | 3.3879 | | 3.5136 | | 3.41 |
| | | 0.2 | A B, MM | 49.61 | 49.79 | 49.59 | 49.52 | 49.79 | 49.75 | 49.86 | 49.85 | |
| | | | H, MM | 49.70 | | 49.55 | | 49.77 | | 49.85 | | |
| | | | V, CM3 | 122.73 | | 121.67 | | 123.26 | | 123.90 | | |
| | | | M, G | 335.00 | | 330.00 | | 330.00 | | 335.00 | | |
| | | | P, G/CM3 | 2.7297 | | 2.7122 | | 2.6772 | | 2.7039 | | 2.71 |
| | | | L, MPA | 3.3850 | | 3.8902 | | 3.8535 | | 3.6576 | | 3.70 |
| | | 0.3 | A B, MM | 49.71 | 49.96 | 49.94 | 50.03 | 49.96 | 50.26 | 49.92 | 49.77 | |
| | | | H, MM | 49.83 | | 49.98 | | 50.11 | | 49.84 | | |
| | | | V, CM3 | 123.75 | | 124.87 | | 125.81 | | 123.82 | | |
| | | | M, G | 345.00 | | 350.00 | | 350.00 | | 350.00 | | |
| | | | P, G/CM3 | 2.7879 | | 2.8029 | | 2.7820 | | 2.8266 | | 2.80 |
| | | | L, MPA | 3.7056 | | 3.9799 | | 3.8376 | | 3.9187 | | 3.86 |
| SINTERED | 2.5 | 0.1 | A B, MM | 47.41 | 47.39 | 47.63 | 47.71 | 47.75 | 47.80 | 47.51 | 47.59 | |

| | H, MM | 47.40 | | 47.67 | | 47.78 | | 47.55 | | |
|---|---|---|---|---|---|---|---|---|---|---|
| | V, CM3 | 106.48 | | 108.33 | | 109.04 | | 107.51 | | |
| | M, G | 285.00 | | 290.00 | | 290.00 | | 290.00 | | |
| | P, G/CM3 | 2.6766 | | 2.6771 | | 2.6595 | | 2.6974 | | 2.68 |
| | L, MPA | 39.9801 | | 37.6342 | | 38.3706 | | 32.1923 | | 37.04 |
| 0.2 | A B, MM | 48.61 | 48.66 | 48.40 | 48.38 | 48.50 | 48.67 | 48.78 | 48.67 | |
| | H, MM | 48.63 | | 48.39 | | 48.58 | | 48.72 | | |
| | V, CM3 | 115.02 | | 113.27 | | 114.65 | | 115.66 | | |
| | M, G | 330.00 | | 325.00 | | 325.00 | | 330.00 | | |
| | P, G/CM3 | 2.8690 | | 2.8691 | | 2.8347 | | 2.8532 | | 2.86 |
| | L, MPA | 60.9483 | | 48.3290 | | 39.7728 | | 40.2977 | | 47.34 |
| 0.3 | AB, MM | 48.93 | 48.87 | 49.18 | 49.15 | 49.12 | 49.34 | 48.96 | 48.74 | |

| | | | | | |
|---|---|---|---|---|---|
| H, MM | 48.90 | 49.16 | 49.23 | 48.85 | |
| V, CM3 | 116.89 | 118.82 | 119.29 | 116.57 | |
| M, G | 345.00 | 350.00 | 350.00 | 345.00 | |
| P, G/CM3 | 2.9514 | 2.9455 | 2.9339 | 2.9596 | 2.95 |
| L, MPA | 55.3300 | 56.9275 | 46.7916 | 40.4016 | 49.86 |

TABLE 3
Properties based on the main embodiments
of the present invention.

| | | roll | expected | |
|---|---|---|---|---|
| | | compres- | strength | |
| Precursor/powder | b/v ratio | sion | (MPa) | density |
| hydroaluminosilicate | 0.28-0.30 | 2.5 | 50-60 MPa | ~2.9 g/ |
| ceramic composition | | | | cm3 |
| cordierite ceramic | 0.30-0.36 | 2.5 | not tested | ~2.1 g/ |
| composition | | | | cm3 |
| mullite-corundum | 0.24-0.28 | 2 | 50-60 MPa | ~2.7 g/ |
| ceramic composition | | | | cm3 |

### Example Embodiments

1. A three-dimensional ceramic printer for printing ceramic articles comprises:
a. a printing chamber,
b. a printing plate movable within the printing chamber via a printing drive,
c. a first feed chamber positioned on a first side of the printing chamber,
d. a first feed plate movable within the first feed chamber via a first feed drive,
e. a second feed chamber positioned on a second side of the printing chamber opposite to the first feed chamber,
f. a second feed plate movable within the second feed chamber via a second feed drive,
g. a guide rail positioned along the printer body above the printing chamber and feed chambers,
h. printing axis movably attached to the guide rail,
i. an axial rotating shaft and a printhead movably attached to the printing axis,
j. a printhead parking space positioned on a side of the printer top surface.

2. A method for three-dimensional ceramic printing via a three-dimensional ceramic printer, wherein the method comprises the following steps:
a. preparing a printer,
b. loading a print media into a printing chamber,
c. loading a binder into a binder container,
d. starting a printing process comprising next steps in a following order:
i. lowering a printing plate in a printing chamber by the layer thickness plus the thickness of its compaction and raising a first feed plate in the first feed chamber by the height, required for feeling the volume formed in the printing chamber and lowering the second feed plate in the second feed chamber by the height required for receiving the surplus of print media remaining after filling the printing chamber;
ii. depositing a layer of print media from the first feed chamber onto the printing plate by translational movement of the shaft, rotating clockwise or counterclockwise depending on the translational movement direction;
iii. lowering the first feed plate for receiving the surplus of print media remaining after compaction, raising the printing plate by the layer compaction height and compaction of the print media layer by translational movement of the shaft, rotating clockwise or counterclockwise depending on the translational movement direction;
iv. lowering the printing plate by the layer thickness plus the thickness of its compaction and depositing binder onto desired portions of the print media in printing chamber by the printhead;
v. optional returning of the printhead to its parking place during binder applying process;
vi. raising the second feed plate by the height, required for feeling the volume formed in the printing chamber and lowering the first feed plate by the height required for receiving the surplus of print media remaining after filling the printing chamber;
vii. depositing a layer of print media from the second feed chamber onto the printing plate by translational movement of the shaft, rotating clockwise or counterclockwise depending on the translational movement direction;
viii. lowering the second feed plate for receiving the surplus of print media remaining after compaction, raising the printing plate by the layer compaction height and compaction of the print media layer by translational movement of the shaft, rotating clockwise or counterclockwise depending on the translational movement direction;
ix. lowering the printing plate by the layer thickness plus the thickness of its compaction and depositing binder onto desired portions of the print media in printing chamber by the printhead;
x. optional returning of the printhead to its parking place during binder applying process;
e. repeating this sequence if the current layer is not the last,
f. repeating the sequence of steps i-ii-vi-vii a number of times if the last layer was printed and the object is formed,
g. ending a printing process.

3. The method of claim 2, wherein a binder may include water as the main component and various auxiliary components designed to make its physical properties acceptable for the printhead and which together is a binding liquid that may be applied to each successive layer of print media by the printhead to bind the print media into the single ceramic object.

4. The method of claim 2, wherein a print media is a/comprises any combination of one or more basic compounds, selected based on the desired chemical composition and technical properties of the final product with other ancillary materials which can play the role of a binding agent, a free-flowing filler, a flux or a shrinkage reducing filler and which together is the ceramic mixture forming the body of the desired ceramic object.

5. The method of claim 2, wherein the value characterizing the necessary and sufficient amount of binding fluid applied to the layers of the ceramic powder-precursor by the printhead for their binding into a single ceramic object is termed binder/volume ratio and varies from 0.24 to 0.36 for different types of ceramic mixtures:
a. from 0.24 to 0.28 for mullite-corundum ceramic compositions
b. from 0.28 to 0.30 for hydro-aluminosilicate ceramic compositions
c. from 0.30 to 0.36 for mullite-corundum ceramic compositions in particular.

6. The method of claim 2, wherein the deposition of the print media from the feed chamber to the printing chamber by the shaft is termed powder spreading and happens alternately from the first feed chamber positioned on the one side of printing chamber and the second feed chamber positioned opposedly to the first feed chamber on the other side of the printing chamber or from the number of feed chambers positioned in pairs on the opposing to each other sides of the printing chamber.

7. The method of claim 2, wherein the densification of the layer of the spread print media with the previous raising of the printing plate to a height corresponding to the degree of densification, is termed layer compaction and occurs during the passage of the shaft over the printing chamber, accompanied by rotation of the shaft in the direction corresponding to the direction of movement of the shaft or in the opposite direction.
